(19) United States
(12) Patent Application Publication
(10) Pub. No.: US 2019/0114733 A1
(43) Pub. Date: Apr. 18, 2019

(54) DISPLAY CONTENT CURRENTNESS VALIDATION

(71) Applicant: Red Hat, Inc., Raleigh, NC (US)

(72) Inventors: Hannes Sowa, Zurich (CH); Sacha Dubois, Zurich (CH)

(21) Appl. No.: 15/782,491

(22) Filed: Oct. 12, 2017

(51) Int. Cl. G06T 1/00; H04N 1/32; H04N 21/2389; H04N 21/8358

(52) U.S. Cl. CPC G06T 1/0064; H04N 1/32154; H04N 1/32192; H04N 2201/327; H04N 21/8358; G06T 2201/0052; H04N 2201/3233; H04N 21/23892

(57) ABSTRACT

Systems and methods for display content currentness validation are disclosed. An example method may include accessing, by a validation module executed by a processing device of a computer system, memory associated with a rendering module executed by a graphics processing unit of the computer system to verify that the rendering module renders up to date content on a display device of the computer system, retrieving, from the memory by the validation module, a timestamp embedded in content rendered by the rendering module on the display device, comparing, by the validation module, the timestamp to a current time of the computer system, and responsive to determining that the timestamp does not correspond to the current time of the computer system, determining that the content rendered by the rendering module on the display device is outdated.

### TECHNICAL FIELD

The disclosure is generally related to computer display, and is more specifically related to display content currentness validation.

### BACKGROUND

A computer system may include software programs and applications that produce visual outputs to be displayed on a display device. These applications do not directly communicate with the display devices. Various computer software and protocols (e.g., application programming interfaces (API), graphics engines, graphics drivers, etc.) may be used to translate high level commands from the applications into low level signals that a graphics hardware (e.g., graphics chipset, graphics cards, etc.) can recognize. A graphics hardware may then manipulate memory associated with a display device according to the signals to render the visual outputs on the display device as a display content.

### BRIEF DESCRIPTION OF THE DRAWINGS

The disclosure is illustrated by way of examples, and not by way of limitation, and may be more fully understood with references to the following detailed description when considered in connection with the figures, in which:

FIG. 1 depicts a high-level diagram of an example computer system in accordance with one or more aspects of the disclosure.

FIG. 2 illustrates example of display devices in accordance with one or more aspects of the disclosure.

FIG. 3 schematically illustrates an example apparatus in which implementations of the disclosure may operate.

FIG. 4 depicts a flow diagram of a method of performing display content currentness validation utilizing timestamps, in accordance with one or more aspects of the disclosure.

FIG. 5 depicts a flow diagram of a method of performing display content currentness validation utilizing hashcodes, in accordance with one or more aspects of the disclosure.

FIG. 6 depicts a block diagram of an illustrative computing device operating in accordance with the examples of the disclosure.

### DETAILED DESCRIPTION

Described herein are methods and systems for performing display content currentness validation. As described above, several intermediate steps may need to be performed from the point an application sends content to be rendered on a display device to the point the content is actually rendered on the display device. Due to various reasons, a computer system may fail to render current content that the application sends for display. For example, some hardware or software component of the computer system may fail to function properly, causing the display failure. A network connection issue may prevent content from being refreshed on a display device. Software components, such as graphics card drivers, can be the source of the failure. Graphic card drivers with plurality of display devices can be particularly vulnerable. Because of one or more of these failures, the display device may continue to display content that was previously rendered for display. These failures can create inconsistencies between the content intended to be displayed and the content that is actually rendered on the display device. These inconsistencies can lead to issues, such as, displaying outdated information on a display device of a user that the user may rely on.

Additionally, rendering outdated information can be particularly problematic for a display device or system where users are viewers who do not generally interact with the computer system, but rely on the information being displayed. The displayed information may be time sensitive and viewers may rely on it being accurate and up to date. When public information systems (e.g., systems intended for public display of information) fail to render up to date content, viewers often may not detect the failure and may be misguided by the outdated information. Public information systems may include, but not be limited to, digital signage systems, systems displaying mass transit timetables, stock tickers, emergency alerts, news and weather updates, hospital displays, patient scheduling data, service schedule, manufacturing and productions information, etc. The users of these systems can be misled and greatly disadvantaged when they rely on outdated display content on a display device in a public space without realizing that it is outdated at the time.

Implementations of the disclosure address the deficiencies related to displaying outdated content on display devices by providing technology to validate display content currentness (i.e., to validate that the content being displayed is up to date or current). Aspects of the present disclosure enable a computer system to self-diagnose that the content rendered on the display device is outdated. The self-diagnosis may be implemented by one part of the computer system validating that another part of the computer system is or is not performing as expected in terms of rendering up to date content. In one example, a computer system may fetch content for display and embed a digital watermark within the content prior to rendering it for display. The digital watermark may include a timestamp representing the time when the content is generated by applications and/or a hashcode of the content generated by applications. A graphics hardware (e.g., a graphics processing unit (GPU)) of the computer system may be used to execute a rendering module to render the content on the display device and store the rendered content and embedded watermark data in a memory associated with the rendering module. If for any reason, a component of the computer system fails to function properly, failing to render current content that the application sends, the display device may continue to display the previously rendered content, including the previously embedded watermark data. Thus, based on the watermark data, it may be determined that the rendered content is outdated. If the system refreshes as expected, the display device may update the rendered content, including the updated watermark data.

In implementations of the disclosure, a validation module of the computer system may validate currentness of the displayed content by accessing the memory and retrieving the embedded watermark data. The validation module may compare the embedded watermark data, (e.g., the timestamp data or the hashcode data) to a current reference data (e.g., a reference data that represents current content, such as, the current time of the computer system or a hashcode of the current content as generated by applications/backend server). If it is determined that the embedded watermark data does not correspond to the current reference data, then it may be determined that the content rendered on the display device is outdated. In response to determining that the content is outdated, a remedial action (e.g., restarting software components, alerting a technician, etc.) may be initiated.

Implementations of the disclosure provide a technical improvement over the conventional systems by utilizing a feedback loop within a computer system to embed a digital watermark within a display content and validate the currentness of the display content using the embedded digital watermark. Computer systems are provided with the capability to self-diagnose display system failures. Through the technologies described in the disclosure, more efficient use of processing resources and data accuracy are provided, while minimizing resource intensive processes and associated costs to ensure up to date information.

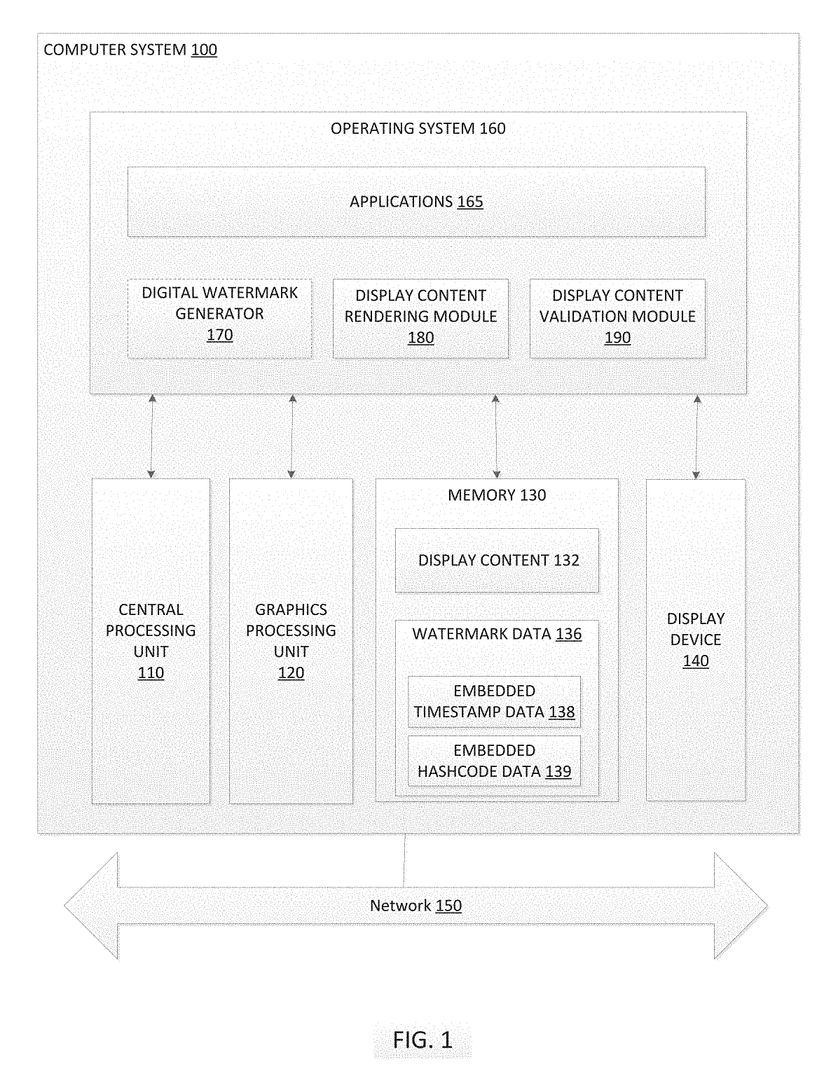

FIG. 1 illustrates a computer system 100 in which embodiments may operate. It should be noted that other architectures for computer system 100 (also referred to herein as system 100) are possible, and that the implementation of a computer system utilizing embodiments of the disclosure are not necessarily limited to the specific architecture depicted by FIG. 1. Terms such as “machine,” “device,” “computer,” and “computing system” may be used interchangeably and synonymously throughout this document.

Computer system 100 may include computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to enable branch rewriting device feature optimization through the embodiments discussed herein. Computer system 100 may include hardware components such as a central processing unit (CPU) 110, graphics processing unit (GPU) 120, memory 130, and display device 140. Computer system 100 may include additional or different components, devices, and/or connectors in various implementations of the disclosure. In some implementations, computer system 100 may be connected to a network 150, which may include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

One or more processors may be embodied as CPU 110, which can be a microprocessor, digital signal processor (DSP), or other processing component. CPU 110 may process various received data and may carry out the code or instructions or one or more computer programs, for example, to provide input/output operations specified by the instructions.

Computer system 100 may include a graphics hardware unit to render display content to a display device. The graphics hardware unit may include an integrated graphics chipset, a graphics controller, a video card (also known as a display card, display adapter, graphics card, graphics adapter), etc. Video cards may include a graphics processing unit (GPU) 120. GPU 120 may have multiple cores that can handle thousands of threads simultaneously. GPU 120 may include an integrated GPU (e.g., utilizes the computer system's shared memory), or a dedicated GPU (e.g., utilizes a memory independent from the system memory and dedicated for the GPU). GPU 120 may include a plurality of GPUs.

Memory 130 may include volatile memory devices (e.g., random access memory (RAM)), non-volatile memory devices (e.g., flash memory), and/or other types of memory devices), and a storage device (e.g., a magnetic hard disk, a Universal Serial Bus [USB] solid state drive, a Redundant Array of Independent Disks [RAID] system, a network attached storage [NAS] array, etc.). Memory 130 may include memory associated with GPU 120. Memory 130 may include a memory that is shared by CPU 110 and GPU 120, a memory that is dedicated to the CPU 110, a memory that is dedicated to the GPU 120, etc.

Display device 120 may include, but are not limited to, liquid crystal displays (LCD), cathode ray tubes (CRT), organic light emitting diodes (OLED), plasma screens, etc. Display device 140 may include a plurality of display devices.

It should be noted that the fact that a single CPU is depicted in FIG. 1 for the computer system 100 is merely illustrative, and that in some other examples the computer system 100 may comprise a plurality of CPUs. Similarly, in some other examples computer system 100 may comprise a plurality of storage devices, plurality of display devices, plurality of GPUs, plurality of memory, etc.

Computer system 100 may further include, although not specifically illustrated herein, a system bus or other communications mechanism for communicating information data, signals, and information between various components (e.g., display device 140, memory 130, etc.) of the system 100. System bus may be utilized to connect one or more attached display device 140 or other components. System bus may transfer data between components inside the system 100 utilizing one or more connections, such as parallel or serial bit connections.

CPU 110 may execute an operating system (OS) program 160 (referred to herein as OS 160), as well as sub-programs and/or applications of OS 160 to provide various features and embodiments described herein. OS 160 may support a plurality of applications 165 residing on the computer system 100. Applications 165 may include, for example, user application processes, virtual machines, containers and the like. Applications 165 may receive data through network 150. OS 160 may support one or more application programming interfaces (API), graphics engines, graphics drivers, etc. (not shown). OS 160 may provide an abstraction layer for the resources (especially CPU 110, GPU 120, memory 130 and display devices 140) that applications 165 may control to perform their function. OS 160 typically makes these resources available to applications 165 through inter-process communication mechanisms and system calls.

Implementations of the disclosure provide a display content currentness validation for display content produced by applications 165 to be rendered on display device 140. In one example, OS 160 may include a digital watermark generator 170, a display content rendering module 180, and a display content validation module 190. Applications 165 may produce commands to generate visual outputs to be rendered on display device 140 on an on-demand basis or on a scheduled frequency. Display content rendering module 180 may directly or indirectly (through APIs, graphics engines, etc.) fetch commands or content from applications 165 to render display content 132.

Digital watermark generator 170 may generate watermark data, which may include timestamp data (indicating the current time), and/or hashcode data of the display content 132 (indicating the current content as produced by the applications 165). Functionality of digital watermark generator 170 may be implemented within any of display content rendering module 180, applications 165, OS 160, another module of the computer system 100, etc.

Display content rendering module 180 may fetch the watermark data and embed it in display content 132. In some implementations, functionality of display content rendering module 180 may be implemented within a graphics driver (not shown). In some implementations, GPU 120 may execute the display content rendering module 180. In other implementations, CPU 110 may execute display content rendering module 180. Display content 132 and watermark data 136, including embedded timestamp data 138 and embedded hashcode data 139, may be stored in memory 130 for display device 140. As a result, display content 132 may be rendered on display device 140.

If for any reason, a component of the computer system fails to function properly, failing to render current content that the application sends, display content 132 may continue hold the previously rendered content, including the previously embedded watermark data. Thus, based on the watermark data 136, it may be determined that the rendered content is outdated. If the system refreshes as expected, display content 132 may be updated with current content, including an updated watermark data.

Display content validation module 190 may be executed to perform operations of the display content currentness validation in accordance with implementations of the disclosure. In some implementations, display content validation module 190 may be executed by CPU 110. In one example, display content validation module 190 may access memory 130 and retrieve watermark data 136 on a specified frequency or on an on-demand basis. Display content validation module 190 may compare watermark data 136 to a current reference data. For example, embedded timestamp data 138 may be compared to a current time of the computer system 100. In another example, embedded hashcode data 139 may be compared to a hashcode of the current content as generated by applications 165 for display. If it is determined that watermark data 136 data does not correspond to the current reference data, then it may be determined that display content 132 rendered on the display device is outdated. In response to determining that display content 132 is outdated, a remedial action (e.g., restarting software components, alerting a technician, etc.) may be initiated.

In one implementation, display content validation module 190 may access memory 130 and retrieve display content 132 rendered on display device 140. A hashcode of display content 132 may be computed in real time and compared to a reference hashcode of the current content as generated by applications 165 for display. If the computed hashcode does not correspond to the reference hashcode, then display content 132 may be determined to be outdated and a remedial measure may be initiated.

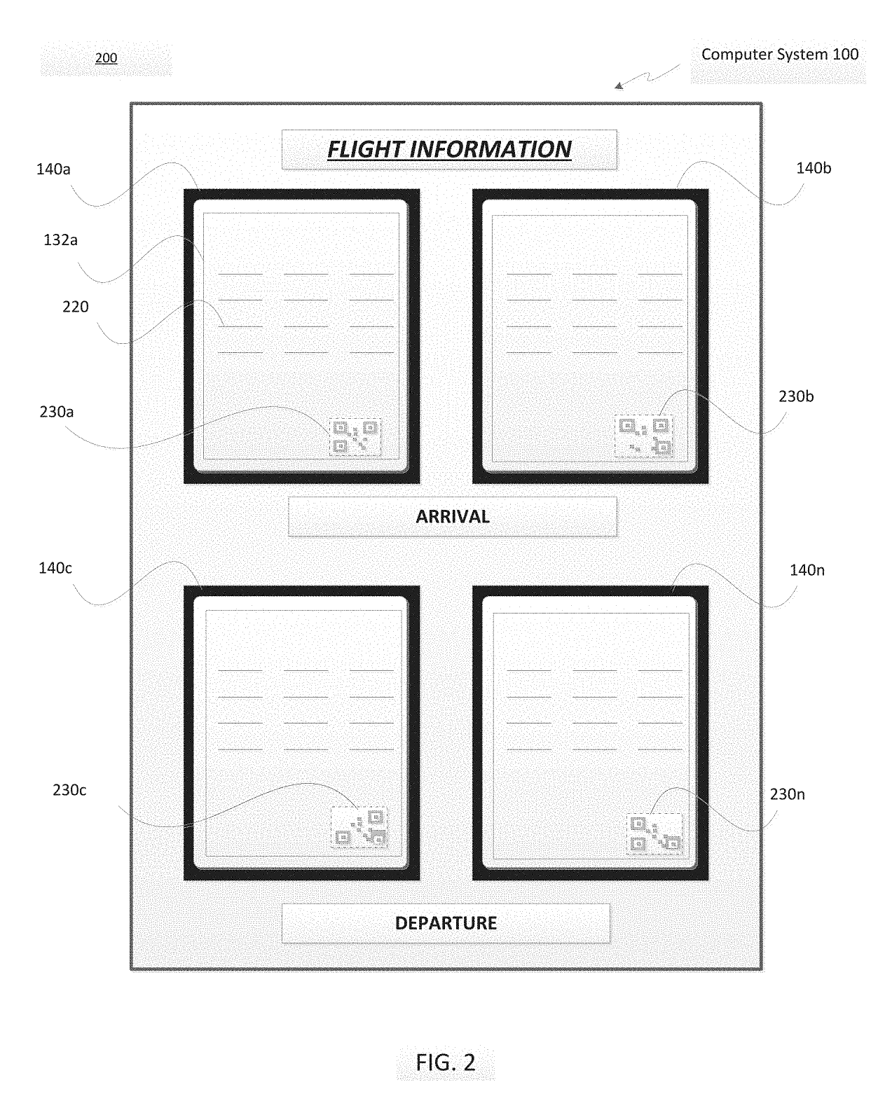

FIG. 2 illustrates examples of display device 140 in accordance with one or more aspects of the disclosure. For example, computer system 100 may be a public information system 200 at an airport terminal that displays flight information such as flight arrival and flight departure schedule and associated information. Computer system 100 may include a plurality of display devices 140a-140n. For example, each of the plurality of display devices 140a-140n may be designed to display different information. For instance, display device 140a and 140b may display flight arrival information whereas display device 140c and 140n may display flight departure information. In an example, display device 140a may be designed to display flight arrival information 220, which may include a timetable of data such as flight time, flight number, city, terminal, gate number, status, etc. Display content 132a may be rendered on display device 140a using flight arrival information 220.

A digital watermark 230a may be embedded into display content 132a. Digital watermark 230a may include a two dimensional barcode (e.g. a QR™ code), a text, an image, etc. For example, a two dimensional barcode may be easy to embed in a display content and easy to scan. In one example, digital watermark 230a may include embedded timestamp data 138 (referring to FIG. 1) that may have been embedded at the time display content rendering module 180 (referring to FIG. 1) may have rendered display content 132a. Digital watermark 230a may include a display device identification number for display device 140a.

In one example, digital watermark 230a may be nearly invisible to human eyes, indicated by the dotted line. To make digital watermark 230a nearly invisible, one of the Red/Green/Blue (RGB) channel of digital watermark 230a may be slightly varied from the display content 132a.

Display content validation module 190 (referring to FIG. 1) may retrieve digital watermark 230a and compare against a current reference data to validate the currentness of the display content 132a. If the validation indicates the two data correspond, then computer system 100 may be assumed to display current and accurate flight information and computer system 100 may continue to show display content 132 on display device 140a without further action. If the validation does not result in corresponding data, computer system 100 may initiate further action to remedy the displaying of outdated information through display content 132. For example, display device 140a may be forcibly powered down in order to prevent viewers from being exposed to outdated content. Alternatively or additionally, computer system 100 may alert a technician to provide attention, restart software associated with display device 140a to bring it back up, etc.

Display content currentness validation may be performed on each of the plurality of display devices 140a-140n as described above in relation to display device 140a. Each of the plurality of display devices 140a-140n may correspond to a plurality of digital watermarks 230a-230n, which may in turn correspond to a plurality of embedded timestamp data, a plurality of embedded hashcode data, a plurality of display device identification numbers, etc. As such, if it is determined that for one of the display devices 140a-140n, the digital watermark data (e.g., timestamp, hashcode, etc.) does not correspond with the current reference data, then the particular display device may be identified by using the corresponding display device identification number. The identified display device may be determined as rendering outdated display content. Accordingly, a remedial action, as described above, may be initiated with respect to the identified display device.

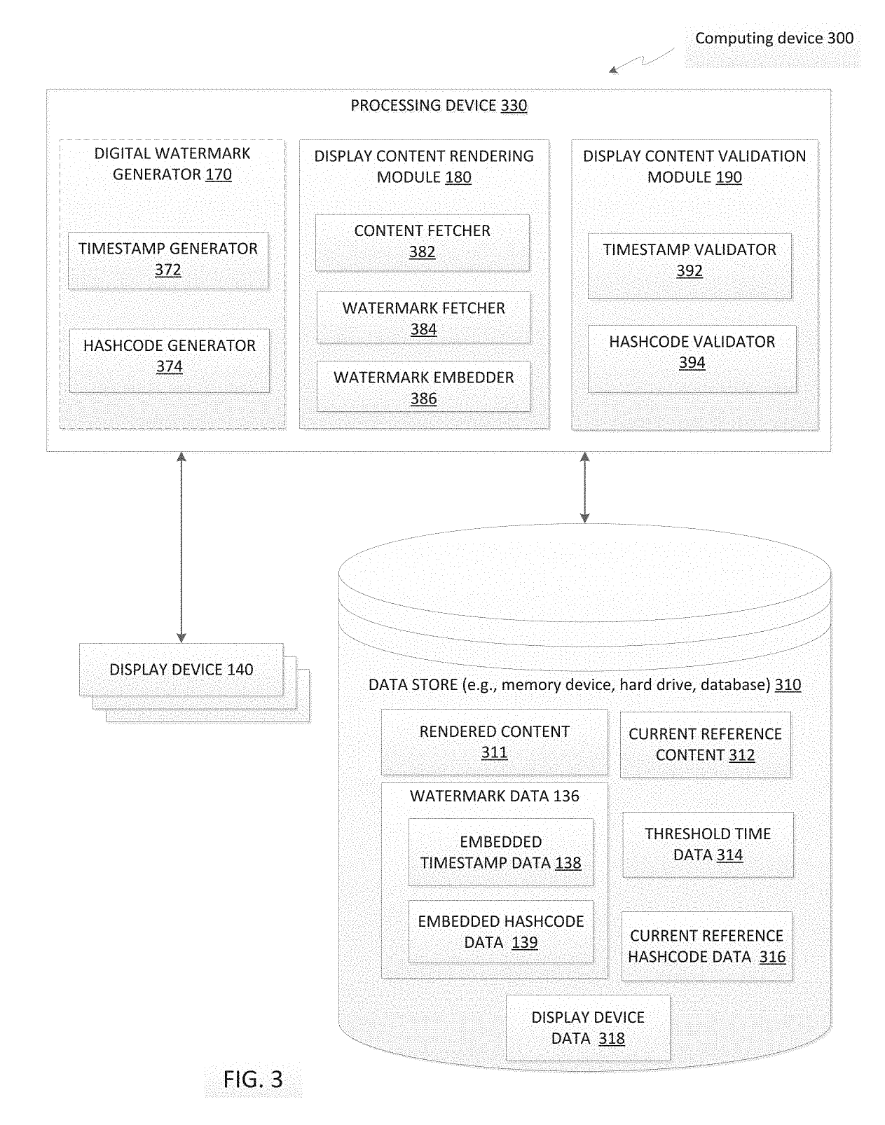

FIG. 3 illustrates an example computing device 300 in which implementations of the disclosure may operate. Computing device 300 may be the same or similar to the computer system 100 described with respect to FIG. 1. Computing device 300 may include components and modules for display content currentness validation. Computing device 300 may include one or more processing devices 330. The one or more processing devices 330 may include one or more central processing unit (CPU) 110, one or more graphics processing unit (GPU) 120, etc.

One or more processing devices 330 may support digital watermark generator 170, display content rendering module 180, display content validation module 190, etc. Digital watermark generator 170 may include a timestamp generator 372 and a hashcode generator 374. Display content rendering module may include a content fetcher 382, watermark fetcher 384, and watermark embedder 386. Display content validation module may include a timestamp validator 392 and a hashcode validator 394.

The computing device 300 may include a data store 310 and one or more display devices 140. The data store 310 can store rendered content 311, current reference content 312, embedded timestamp data 138, threshold time data 314, embedded hashcode data 139, current reference hashcode data 316, display device data 318, etc. The data store 310 may include any non-persistent data storage (e.g., memory 130), persistent data storage (e.g., flash storage, hard drive, tape), other medium, or combination thereof that is capable of storing instructions for carrying out the operations of the components and modules discussed herein. Display device 140 may include, but are not limited to, liquid crystal displays (LCD), cathode ray tubes (CRT), organic light emitting diodes (OLED), plasma screens, etc. Display device 140 may include a plurality of display devices.

In implementations of the disclosure, one or more processing devices 330 may execute display content rendering module 180 to generate display content 132. Content fetcher 382 of display content rendering module 180 may fetch content from applications 165 to generate display content 132 and store the content in the memory 130 as rendered content 311. Digital watermark generator 170, which may be implemented within or outside of display content rendering module 180, may be executed to generate watermark data 136. Watermark embedder 386 may embed watermark data 136 in display content 132 along with rendered content 311. Display content 132 may be rendered on display device from memory 130.

One or more processing devices 330 may also execute display content validation module 190, which may access memory 130 and retrieve watermark data 136 stored therein. Watermark data 136 may be compared with a current reference data (e.g., threshold time data 314, current reference hashcode data 316, etc.) stored in memory 130 and determine whether watermark data 136 correspond with the current reference data. If the watermark data 136 corresponds with the current reference data, display content 132 rendered on display device 140 may be determined to be current or up to date. If the watermark data 136 does not correspond with the current reference data, display content 132 rendered on display device 140 may be determined to be outdated.

The watermark data may include a timestamp data. For example, timestamp generator 372 may generate a timestamp at the time applications 165 sends content to be rendered on display device 140. In another example, the timestamp may be generated at the time the content is fetched by content fetcher 382. The timestamp may be fetched by the watermark fetcher 384 and embedded by the watermark embedder 386 into display content 132, and stored in memory 130 as embedded timestamp data 138.

An embedded timestamp data may be compared to a current reference time data. For example, embedded timestamp data 138 may be retrieved from memory 130 and compared to a current time of the computing device 300 by timestamp validator 392 of display content validation module 190. If the embedded timestamp data 138 matches the current time of the computing device, rendered content 311 may be determined as current.

In another implementation, a threshold time data 314 may be stored in memory 130. Threshold time data 314 may represent the frequency with which display content 132 may be expected to be refreshed. For example, for a flight information system, display content may be refreshed every 10 seconds, whereas for a car service schedule table, display content may be set to refresh every 5 minutes. Additionally, threshold time data 314 may be configurable by a user or an administrator.

Timestamp validator 392 may compare embedded timestamp data 138 to a current reference data by computing a difference between the retrieved embedded timestamp data 138 and the current time of the computing device 300. Timestamp validator 392 may compare the difference to threshold time data 314. In one example, if the difference is less than threshold time data 314, display content 132 may be determined to be up to date. If the difference is equal or more than the threshold time data 314, display content 132 may be considered not to correspond to the current reference data and be determined as outdated.

The watermark data may also include hashcode data. For example, hashcode generator 374 of digital watermark generator 170 may generate a hashocde of the content to be rendered at the time applications 165 sends content to be rendered on display device 140. The content to be rendered may be stored in memory 130 as current reference content 312 and the generated hashcode may be stored as current reference hashcode data 316. The generated hashcode may also be fetched by watermark fetcher 384, embedded by the watermark embedder 386 into display content 132, and stored in memory 130 as embedded hashcode data 139.

Hashcode validator 394 of display content validation module 190 may retrieve the embedded hashcode data 139 from memory 130 and compare it to current reference hashcode data 316. In one example, if the two data do not match, display content 132 may be considered not to correspond to the current reference data and be determined as outdated. If the two data match, display content 132 may be determined as being up to date.

In some implementations, display content validation module 190 may access memory 130 and retrieve rendered content 311. Rendered content 311 may be in a machine readable format. In one example, rendered content 311 may be compared to current reference content 312. In another example, a hashcode of rendered content 311 may be computed in real time and compared to current reference hashcode data 316. In yet another example, a hashcode of the current reference content 312 may be computed in real time and be compared to a hashcode of rendered content 311 that may be computed in real time. If the result of the comparison does not indicate corresponding data, then display content 132 may be determined to be outdated and a remedial measure may be initiated.

In some implementations, instead of hashcodes, a checksum, ID, or serial number of display content may be calculated and used for the content comparisons.

The watermark data may include display device data. For example, display device data 318 may include a display device identification number, a physical location of the display device, etc. When display device 140 includes a plurality of display devices, device data 318 may include an identification number corresponding to one of the plurality of display devices for each of the watermark data generated for the plurality of display devices.

Display content validation module 190 may retrieve digital watermark and associated data using various mechanisms. The particular mechanism used may depend on a specific hardware used and the capabilities of the specific hardware. In some implementations, as described above, display content 132 (including the rendered content 311 and watermark data 136) may be stored in memory 130 and accessed by display content validation module 190. Display content 132 may be decoded to retrieve watermark data 136 embedded therein. In one example, display content 132 may be scanned to obtain a two-dimensional bar code included in the digital watermark (e.g., digital watermark 230a referred in FIG. 2). The two-dimensional bar code may include watermark data 136 that was embedded by watermark embedder 386. Memory 130, where watermark data 136 may be stored, may be directly associated with display content rendering module 180. In some examples, memory 130 may be coupled to the GPU 120. In some implementations, retrieving watermark data from a memory that is closest to the hardware (e.g., GPU) may provide for more precise determination of content that is actually rendered on the display device, which can in turn provide for a more accurate determination of currentness of display content. Format of the data retrieved from the memory may depend on the particular hardware used. Some example formats may include bitmap files, JPEG files, etc.

Another mechanism used to retrieve a digital watermark and associated data would be to obtain a screenshot of the display content. For example, a screenshot may be obtained of display content 132 that is rendered on a display device for use by the display content validation module 190. The screenshot may be obtained using functionalities of various software components within computer system, such as the graphics driver, application layer, the OS, etc. The screenshot mechanism may be readily available to implement using existing resources of the computer system.

Processing device 330 may execute display content validation module 190 on demand or at a specified frequency. Regular and/or more frequent validation may be desirable for a system that continuously updates information for display to ensure currentness of display content. In the case of a specified frequency, display content validation module 190 may be executed at least as frequently as display content 132 is expected to be refreshed (e.g., threshold time data 314), and possibly more frequently. For example, display content 132 maybe expected to refresh every 2 minutes and thus threshold time data 314 may be set to 2 minutes. In that example, the specified frequency for executing display content validation module 190 may be set to every 1 minute.

Referring to FIGS. 2 and 3, example scenarios are illustrated herein in accordance with aspects of the disclosure. One or more processing devices 330 may execute display content rendering module 180 to generate a flight arrival timetable for display content 132a on display device 140a having an identification number “777.” For example, the flight arrival timetable may contain timetable entry Flight Number EK1234 arriving at Terminal 1, Gate 5, at 8:30 am on Jan. 1, 2018. Applications 165 associated with public information system 200 may generate this information at 6:00 am on Jan. 1, 2018. Digital watermark generator 170 may generate a digital watermark 230a utilizing timestamp generator 372. A timestamp with a value of “2018-01-01-06:00:00” may be generated and embedded into display content 132a, which may also include the timetable entry for Flight Number EK1234. Watermark embedder 386 may also embed display device identification number “777” into display content 132a. Display content 132a may be rendered on display device 140a with the timetable entry and an invisible digital watermark. Threshold time data 314 may be set to 10 seconds, as the display is expected to be refreshed every 10 seconds.

Display content validation module 190 may have a specified frequency to run every 5 seconds. At 6:00:05 am, display content validation module 190 may access memory 130 and retrieve the embedded timestamp data 138 which may have a value of “2018-01-01-06:00:00.” Difference between current time 6:00:05 and timestamp value 06:00:00 am maybe computed to obtain a value of 5 seconds, which is less than threshold time data of 10 seconds. Thus currentness of display content 132a may be validated.

At 6:00:10 am, an updated timetable may be generated and rendered for display with an update to arrival time being 8:10 am and a timestamp of 6:00:10 am. Display content validation module 190 may compare this timestamp at 6:00:10 am to the current time and determine that the timestamp correspond with the current time. At 6:00:20 am an update to the timetable is generated to indicate updated “Gate 40,” however, due to some issue the update may not get rendered on the display device 140a, displaying the previously rendered table with “Gate 5” and embedded timestamp of “6:00:10 am.” At 6:00:25 am the timestamp validator 392 determines that the difference between current time and embedded timestamp is 15 seconds, which is more than the threshold time of 10 seconds. As such, display content 132a with a display device identification number “777” may be determined to be outdated. A remedial action, such as restarting the computer system may be initiated, preventing the viewers from being exposed to wrong gate number on the display device 140a.

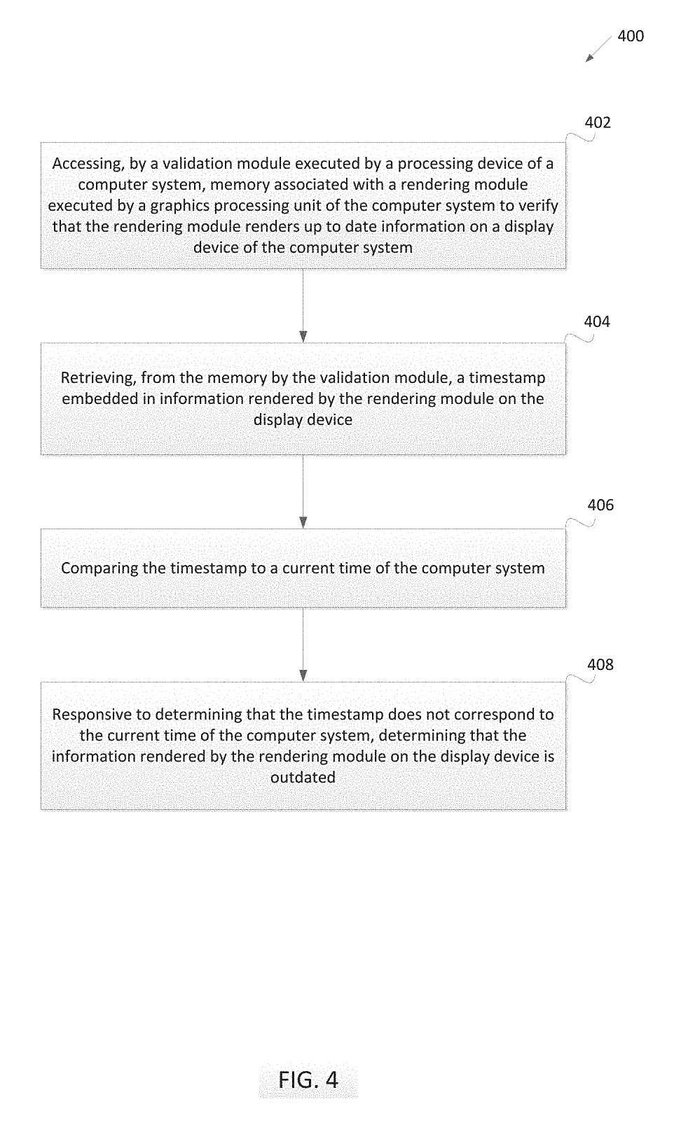

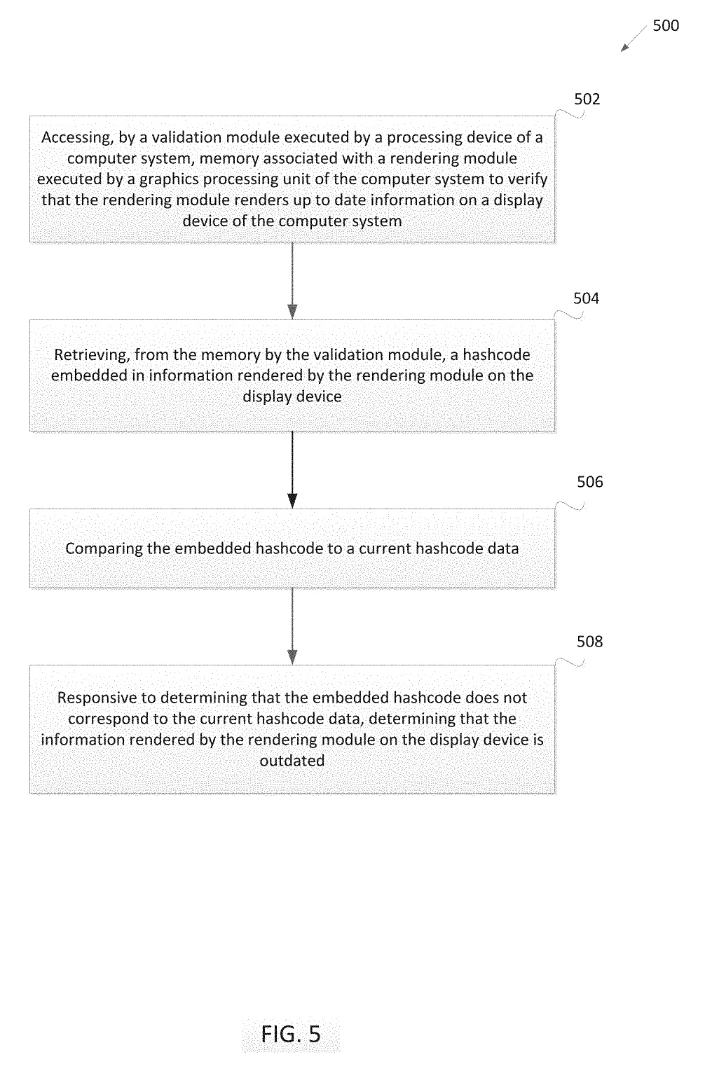

FIGS. 4 and 5 depict flow diagrams for illustrative examples of methods 400 and 500 for display content currentness validation. Method 400 includes a method of performing display content currentness validation utilizing a timestamp embedded in a display content. Method 500 includes a method of performing display content currentness validation utilizing a hashcode embedded in a display content. Methods 400 and 500 may be performed by processing devices that may comprise hardware (e.g., circuitry, dedicated logic), computer readable instructions (e.g., run on a general purpose computer system or a dedicated machine), or a combination of both. Methods 400 and 500 and each of their individual functions, routines, subroutines, or operations may be performed by one or more processors of the computer device executing the method. In certain implementations, methods 400, and 500 may each be performed by a single processing thread. Alternatively, methods 400 and 500 may be performed by two or more processing threads, each thread executing one or more individual functions, routines, subroutines, or operations of the method.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be needed to implement the methods in accordance with the disclosed subject matter. In addition, those skilled in the art understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media.

Referring to FIG. 4, method 400 may be performed by one or more processing devices of the computer system. At block 410, a validation module executed by the processing device may access memory associated with a rendering module executed by a graphics processing unit of the computer system to verify that the rendering module renders up to date content on a display device of the computer system. The memory may be a memory shared by the processing device and the graphics processing unit. Alternatively, the memory may be a memory dedicated for the graphics processing unit.

At block 404, the validation module may retrieve from the memory a timestamp embedded in content rendered by the rendering module on the display device. The timestamp may be retrieved via a feedback loop within the computer system. In one example, the timestamp may be embedded in the content at the time the rendering module renders the content for the display device. Additionally, the timestamp may be embedded in the content by the rendering module. The timestamp may also be generated by the rendering module. In some implementations, the timestamp may be embedded within a digital watermark. The digital watermark may comprise a two dimensional barcode. The digital watermark may include an identification number for the display device. In some example, the digital watermark may be nearly invisible.

At block 406, the validation module may compare the timestamp to a current time of the computer system. In one example, the comparing may include computing a difference between the timestamp and the current time and comparing the difference to a predetermined threshold time. The predetermined threshold time may be configurable by the computer system.

Subsequently, at block 408, responsive to determining that the timestamp does not correspond to the current time of the computer system, the processing device may determine that the content rendered by the rendering module on the display device is outdated. In one example, determining that the timestamp does not correspond to the current time of the computer system may include determining that the difference is more than the predetermined threshold time. Subsequent to determining that the content rendered by the rendering module on the display device is outdated, the processing device may initiate a remedial action to remedy the outdated content rendered on the display device.

Referring to FIG. 5, method 500 may be performed by one or more processing devices of the computer system. Method 500 may begin at block 510, where a validation module executed by the processing device may access memory associated with a rendering module executed by a graphics controller of the computer system to verify that the rendering module renders up to date content on a display device of the computer system. The memory may be a memory shared by the processing device and the graphics controller. Alternatively, the memory may be a memory dedicated for the graphics controller.

At block 504, the validation module may retrieve from the memory a hashcode embedded in content rendered by the rendering module on the display device. The hashcode may be retrieved via a feedback loop within the computer system. In one example, the hashcode may be embedded in the content at the time the rendering module renders the content for the display device. Additionally, the hashcode may be embedded in the content by the rendering module. In some implementations, the hashcode may be embedded within a digital watermark. The digital watermark may comprise a two dimensional barcode. The digital watermark may include an identification number for the display device. In some example, the digital watermark may be nearly invisible.

At block 506, the validation module may compare the embedded hashcode to a current reference hashcode data. Subsequently, at block 508, responsive to determining that the embedded hashcode does not correspond to the current reference hashcode data, the processing device may determine that the content rendered by the rendering module on the display device is outdated. Subsequent to determining that the content rendered by the rendering module on the display device is outdated, the processing device may initiate a remedial action to remedy the outdated content rendered on the display device.

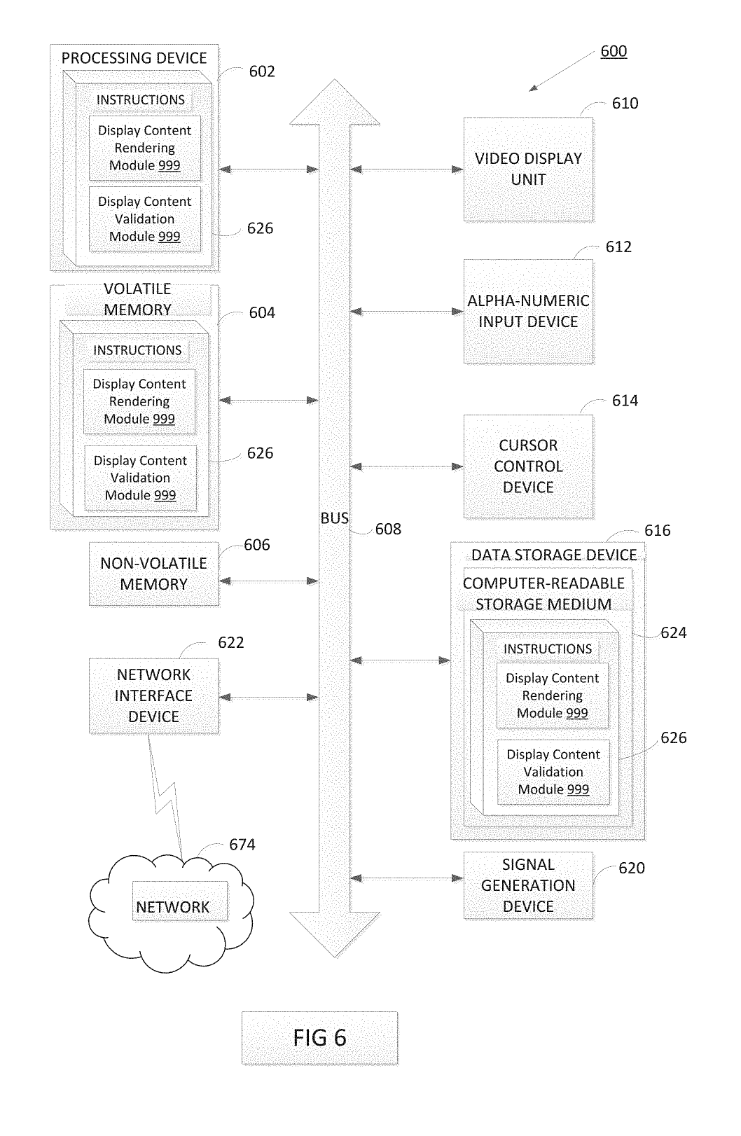

FIG. 6 depicts a block diagram of a computer system operating in accordance with one or more aspects of the disclosure. In various illustrative examples, computer system 600 may correspond to a computing device, such as computer system 100 of FIG. 1. The computer system may be included within a data center that supports virtualization. Virtualization within a data center results in a physical system being virtualized using VMs to consolidate the data center infrastructure and increase operational efficiencies. A VM may be a program-based emulation of computer hardware. For example, the VM may operate based on computer architecture and functions of computer hardware resources associated with hard disks or other such memory. The VM may emulate a physical computing environment, but requests for a hard disk or memory may be managed by a virtualization layer of a host machine to translate these requests to the underlying physical computing hardware resources. This type of virtualization results in multiple VMs sharing physical resources.

In certain implementations, computer system 600 may be connected (e.g., via a network, such as a Local Area Network (LAN), an intranet, an extranet, or the Internet) to other computer systems. Computer system 600 may operate in the capacity of a server or a client computer in a client-server environment, or as a peer computer in a peer-to-peer or distributed network environment. Computer system 600 may be provided by a personal computer (PC), a tablet PC, a set-top box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 600 may include a processing device 602, a volatile memory 604 (e.g., random access memory (RAM)), a non-volatile memory 606 (e.g., read-only memory (ROM) or electrically-erasable programmable ROM (EEPROM)), and a data storage device 616, which may communicate with each other via a bus 608.

Processing device 602 may be provided by one or more processors such as a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

Computer system 600 may further include a network interface device 622. Computer system 600 also may include a video display unit 610 (e.g., an LCD), an alphanumeric input device 612 (e.g., a keyboard), a cursor control device 614 (e.g., a mouse), and a signal generation device 620.

Data storage device 616 may include a non-transitory computer-readable storage medium 624 on which may store instructions 626 encoding any one or more of the methods or functions described herein, including instructions for a display content rendering module 180, a display content validation module 190, and/or a digital watermark generator 170 of FIG. 1 for implementing methods 400 and/or 500 of FIGS. 4 and 5.

Instructions 626 may also reside, completely or partially, within volatile memory 604 and/or within processing device 602 during execution thereof by computer system 600, hence, volatile memory 604 and processing device 602 may also constitute machine-readable storage media.

While computer-readable storage medium 624 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and computer program components, or in computer programs.

Unless specifically stated otherwise, terms such as “receiving,” “invoking,” “associating,” “providing,” “storing,” “performing,” “utilizing,” “deleting,” “initiating,” “marking,” “generating,” “recovering,” “completing,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and may not have an ordinal meaning according to their numerical designation.

Examples described herein also relate to an apparatus for performing the methods described herein. This apparatus may be specially constructed for performing the methods described herein, or it may comprise a general purpose computer system selectively programmed by a computer program stored in the computer system. Such a computer program may be stored in a computer-readable tangible storage medium.

The methods and illustrative examples described herein are not inherently related to any particular computer or other apparatus. Various general purpose systems may be used in accordance with the teachings described herein, or it may prove convenient to construct more specialized apparatus to perform methods 400 and 500 and/or each of its individual functions, routines, subroutines, or operations. Examples of the structure for a variety of these systems are set forth in the description above.

The above description is intended to be illustrative, and not restrictive. Although the disclosure has been described with references to specific illustrative examples and implementations, it should be recognized that the disclosure is not limited to the examples and implementations described. The scope of the disclosure should be determined with reference to the following claims, along with the full scope of equivalents to which the claims are entitled.

What is claimed is:

1. A method comprising:
accessing, by a validation module executed by a processing device of a computer system, memory associated with a rendering module executed by a graphics processing unit of the computer system to verify that the rendering module renders up to date content on a display device of the computer system;
retrieving, from the memory by the validation module, a timestamp embedded in content rendered by the rendering module on the display device;
comparing, by the validation module, the timestamp to a current time of the computer system; and
responsive to determining that the timestamp does not correspond to the current time of the computer system, determining that the content rendered by the rendering module on the display device is outdated.

2. The method of claim 1, wherein the timestamp is embedded in the content at the time the rendering module renders the content for the display device.

3. The method of claim 1, wherein the comparing comprises:
computing a difference between the timestamp and the current time; and
comparing the difference to a predetermined threshold time that is configurable by the computer system.

4. The method of claim 3, wherein the determining that the timestamp does not correspond to the current time of the computer system comprises:
determining that the difference is more than the predetermined threshold time.

5. The method of claim 1, further comprising:
in response to determining that the content rendered by the rendering module on the display device is outdated, initiating, by the computer system, a remedial action to remedy the outdated content rendered on the display device.

6. The method of claim 1, wherein the timestamp is retrieved via a feedback loop within the computer system.

7. The method of claim 1, wherein the timestamp is embedded in the content by the rendering module.

8. The method of claim 1, wherein the timestamp is generated by the rendering module.

9. The method of claim 1, wherein the timestamp is embedded within a digital watermark.

10. The method of claim 9, wherein the digital watermark comprises a two dimensional barcode.

11. The method of claim 9, wherein the digital watermark includes an identification number for the display device.

12. The method of claim 9, wherein the digital watermark is nearly invisible.

13. A system comprising:
a memory device;
a processing device, coupled to the memory; and
a plurality of display devices, coupled to the processing device, wherein the processing device is to:
access, by a validation module, one or more memories associated with one or more rendering modules executed by one or more graphics processing units of the system to verify that the one or more rendering modules render up to date content on each of the plurality of display devices;
retrieve, from the one or more memories by the validation module, a plurality of timestamps, wherein each of the plurality of timestamps is embedded in corresponding content rendered by the one or more rendering modules on each of the plurality of display devices;
compare, by the validation module, each of the plurality of timestamps to a current time of the system; and
responsive to determining that at least one of the plurality of timestamps does not correspond to the current time of the system, determine that the corresponding content rendered by the one or more rendering modules on at least one of the plurality of display devices is outdated.

14. The system of claim 13, wherein the processing device is further to:
retrieve, from the one or more memories by the validation module, a plurality of display device identification numbers, wherein each of the plurality of display device identification numbers corresponds with one of the plurality of display devices.

15. The system of claim 14, wherein each of the plurality of timestamps corresponds to a different one of the plurality of display device identification numbers.

16. The system of claim 15, where the processing device is further to:
identify, by the validation module, the at least one of the plurality of display devices that is outdated using the at least one of the plurality of timestamps and the corresponding one of the plurality of display device identification numbers.

17. The system of claim 13, wherein the processing device is further to:
in response of the determination that the corresponding content rendered by the one or more rendering modules on at least one of the plurality of display devices is outdated, initiate a remedial action to remedy the outdated content rendered on the at least one of the plurality of display devices.

18. The system of claim 15, wherein each of the plurality of timestamps and corresponding one of the plurality of display device identification numbers are embedded within a digital watermark.

19. The system of claim 18, wherein the digital watermark comprises a two dimensional barcode.

20. A non-transitory device-readable medium storing instructions that, when executed by a processing device associated with a computer system, cause the processing device to perform operations comprising:
accessing, by a validation module executed by the processing device, memory associated with a rendering module executed by a graphics processing unit of the computer system to verify that the rendering module renders up to date content on a display device of the computer system;
retrieving, from the memory by the validation module, a timestamp embedded in content rendered by the rendering module on the display device;
comparing, by the validation module, the timestamp to a current time of the computer system; and
responsive to determining that the timestamp does not correspond to the current time of the computer system, determining that the content rendered by the rendering module on the display device is outdated.
